(19) United States
(12) Patent Application Publication
(10) Pub. No.: US 2014/0246007 A1
(43) Pub. Date: Sep. 4, 2014

(54) GRILL AND METHOD OF USE

(71) Applicants: Minh N. Nguyen, Atlanta, GA (US); Tim Jackovitch, Ellijay, GA (US)

(72) Inventors: Minh N. Nguyen, Atlanta, GA (US); Tim Jackovitch, Ellijay, GA (US)

(21) Appl. No.: 14/081,608

(22) Filed: Nov. 15, 2013

Related U.S. Application Data
(60) Provisional application No. 61/771,147, filed on Mar. 1, 2013.
(60) Provisional application No. 61/823,260, filed on May 14, 2013.
(60) Provisional application No. 61/823,490, filed on May 15, 2013.
(60) Provisional application No. 61/841,727, filed on Jul. 1, 2013.

(51) Int. Cl. A47J 37/07; F24C 15/00

(52) U.S. Cl. CPC A47J 37/0786; F24C 15/001
USPC 126/25 R; 126/287

(57) ABSTRACT

A grill includes a grill base and a grill lid that is in hinged communication with the grill base and includes an opening on a top wall of the grill lid. The grill further includes a grill flue that includes a front panel that is in hinged communication with the grill lid at the opening of the top wall of the grill lid, and an opening system that is coupled to the grill base and the grill flue, wherein the opening system assists in erecting the front panel as the grill lid is being opened.

### CROSS REFERENCE TO RELATED APPLICATIONS

This application claims the benefit of U.S. provisional application entitled, “Improvements to Grills,” having Ser. No. 61/771,147, filed on Mar. 1, 2013, the benefit of U.S. provisional application entitled, “Improvements to Grills,” having Ser. No. 61/823,260, filed on May 14, 2013, the benefit of U.S. provisional application entitled, “Improvements to Grills,” having Ser. No. 61/823,490, filed on May 15, 2013, the benefit of U.S. provisional application entitled, “Improvements to Grills,” having Ser. No. 61/841,727, filed on Jul. 1, 2013, all of which are entirely incorporated herein by reference.

### TECHNICAL FIELD

The present disclosure is generally related to grills and methods of use thereof and, more particularly, is related to grills having a flue that facilitates directing heat and smoke away from the front of the grill.

### BACKGROUND

Barbeque pits are desirable for many occasions that require food to be cooked outdoors, such as family reunions, picnics, barbeques and company functions. Most available grills contain a door, which is opened to remove or add food to the grill, or to check on the cooking progress of the food. In order to open the door, however, the user has to stand relatively close to the front of the grill, and upon opening the door, the user is met with a blast of hot smoke. Such a situation is not only inconvenient, but also dangerous, as a user may inhale hot and intense smoke fumes.

Several previous devices have attempted to overcome the aforementioned problem with varying levels of success. One such device teaches a grill with a conventional grill cover that has an opening with a transparent vent window covering the opening. In use, the vent window selectively rotates about its front hinge, thereby causing the rear portion of the vent window to rise at a desirable angle away from the grill cover, and therefore exposing the opening. While such a device creates an opening through which smoke escapes, it lacks the ability to create a flue effect to direct smoke away from the user towards the rear of the grill when the grill cover is in an open position.

Another device teaches a typical grill lid having an opening and a glass panel. The glass panel is slidable along lined tracks. The glass panel may be slid inwardly to cover the opening or outwardly to expose the opening. While such a device covers the opening of a grill, the glass panel is not taught to be removable during the cooking process, and is only taught to be removable for cleaning purposes. Further, such a device lacks the ability to create a flue that moves smoke to the rear of the grill as the smoke exits.

Desirable in the art is an improved grill lid that would improve upon the conventional grill lid.

### SUMMARY

A grill includes a grill base and a grill lid that is in hinged communication with the grill base and includes an opening on a top wall of the grill lid. The grill further includes a grill flue that includes a front panel that is in hinged communication with the grill lid at the opening of the top wall of the grill lid, and an opening system that is coupled to the grill base and the grill flue, wherein the opening system assists in erecting the front panel as the grill lid is being opened.

### BRIEF DESCRIPTION OF THE DRAWINGS

FIG. 1 is a perspective view of a grill lid that illustrates an embodiment of the present invention from the front, top, and right side views;

FIG. 2 is a front view of a grill lid that illustrates an embodiment of the present invention;

FIG. 3 is a perspective view of a grill lid that illustrates an embodiment of the present invention from the rear, top, and left side views in which a concealed grill flue is being partially erected or closed;

FIG. 4 is a perspective view of a grill lid that illustrates an embodiment of the present invention from the rear, top, and left side views in which a concealed grill flue is being partially erected using a lever system;

FIG. 5 is a perspective view of a grill lid having an erected grill flue that illustrates an embodiment of the present invention from the front, top, and left side views;

FIG. 6 is a perspective view of a grill lid that illustrates an embodiment of the present invention from the rear, top, and left side views;

FIGS. 7-10 are cross-sectional side views of a grill lid and a concealed grill flue that illustrate an embodiment of the present invention in a closed position, partially closed/opened position, and opened position;

FIGS. 11-13 are cross-sectional side views of a grill lid and a concealed grill flue that illustrate another embodiment of the present invention in a closed position, partially closed/opened position, and opened position;

FIG. 14 is a cross-sectional side view of an erected grill flue on a roll top grill lid in accordance with an embodiment of the present invention;

FIGS. 15-16 are cross-sectional side views of a side panel of a grill flue that includes a first portion and a second portion in accordance with an embodiment of the present invention;

FIGS. 18-21 are cross-sectional views of a grill lid having a grill flue that can be erected by way of a pulley system in accordance with an embodiment of the present invention;

FIGS. 20-21 are cross-sectional views of a grill having a grill flue that can be erected by way of a pulley system in accordance with another embodiment of the present invention; and

FIG. 22 is a perspective view of a grill lid that illustrates another embodiment of the present invention from the top, side, and rear views.

### DETAILED DESCRIPTION

Exemplary systems are first discussed with reference to the figures. Although these systems are described in detail, they are provided for purposes of illustration only and various modifications are feasible.

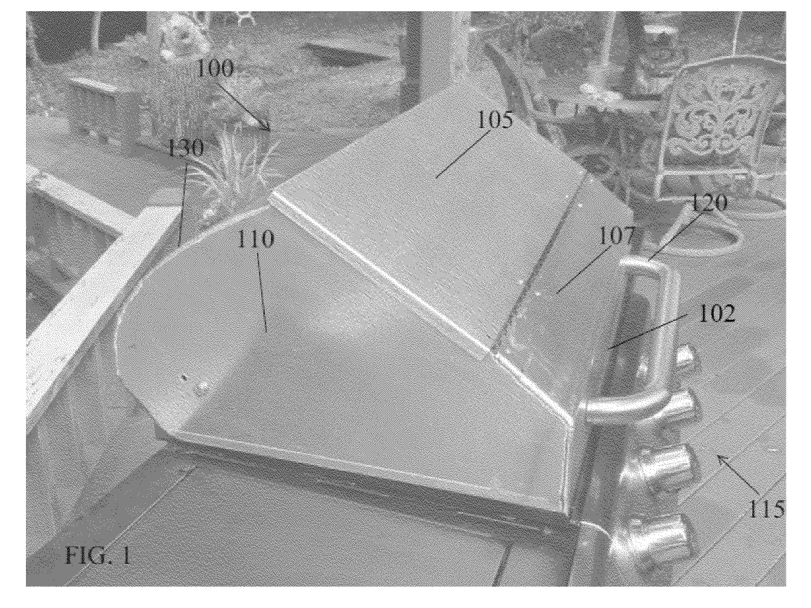

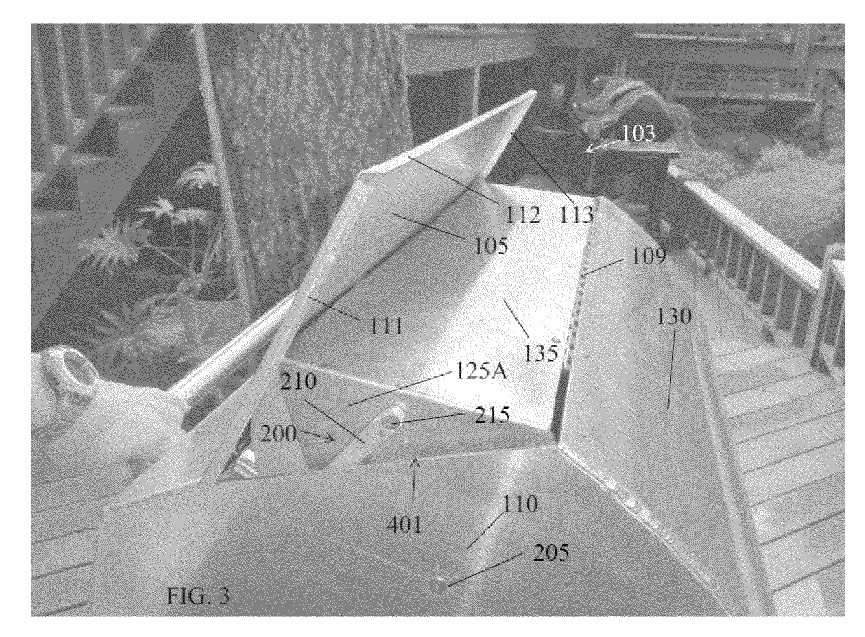

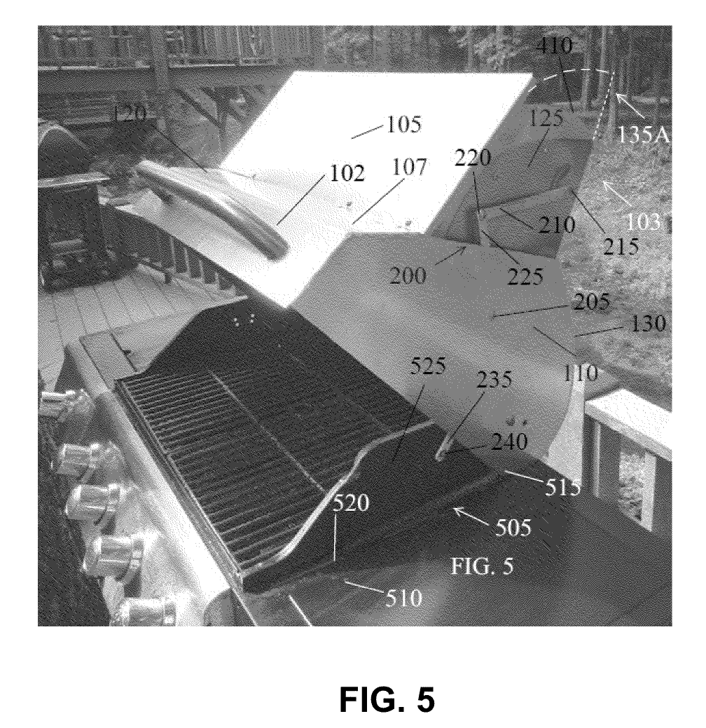

FIG. 1 is a perspective view of a grill lid 100 that illustrates an embodiment of the present invention from the front, top, and right side views. The grill lid 100 is placed on top of a grill base 115 and is attached with a handle 120 that is disposed at a front wall 102 of the grill lid 100. The grill lid 100 is in hinged communication with the grill base 115. The grill lid 100 further includes side walls 110 and a rear wall 130 (FIG. 3). In this example, from a side view, the shape of the grill lid 100 is substantially a pyramid. The rear wall 130 can be concaved towards the inside of the grill lid 100. The top wall 107 includes an opening 401 (FIG. 3) that is covered by a front panel 105 of a concealed grill flue 103 (FIG. 5) that is named the “Grillvex” by the inventors. The concealed grill flue 103 is further described in connection to FIGS. 3-22.

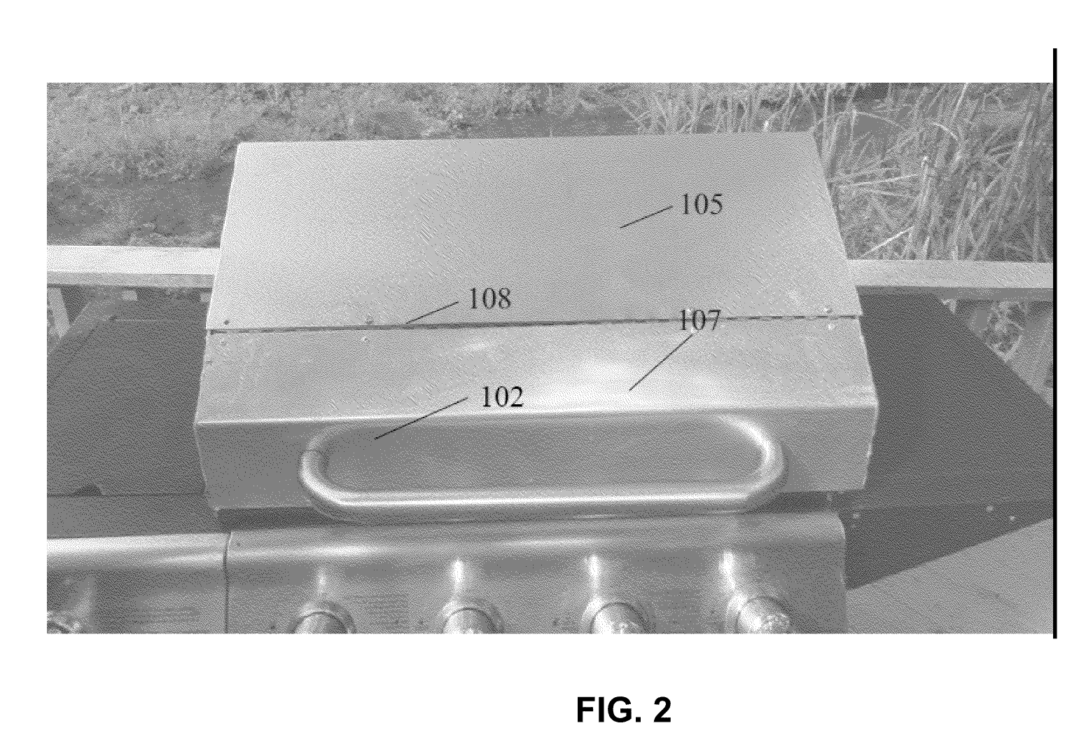

FIG. 2 is a front view of a grill lid 100 that illustrates an embodiment of the present invention. The front panel 105 is in hinged communication with the grill lid 100 at the opening 401 of the top wall 107 of the grill lid 100. In this example, the front panel 105 is attached via a hinge 108 at a bottom edge of the front panel 105 to a top edge of the top wall 107 such that the top edge of the front panel 105 opens away from the rear wall 130. Alternatively or additionally, the front panel 105 can be attached via the hinge 108 at a bottom edge to a top edge of the front wall 102.

FIG. 3 is a perspective view of a grill lid 100 that illustrates an embodiment of the present invention from the rear, top, and left side views in which a concealed grill flue 103 is being partially erected or closed. The concealed grill flue 103 further includes side panels 125A, B and a rear panel 135 that is in hinged communication (e.g., a hinge 109) at the opening of the top wall 107 of the grill lid 100. In this example, the front and rear panels 105, 135 are hinged via hinges 108, 109 at a front edge and a rear edge of the opening 401 of the top wall 107 of the grill lid 100, respectively. The rear panel 135 is attached to the side panels 125A, B at the left and right side edges of the rear panel 135. The side panels 125A, B are positioned substantially perpendicular to the planar surface of the rear panel 135 and extend towards the inside the grill lid 100.

In a closed position of the concealed grill flue 103, the front panel 105 covers the rear panels 135 and the opening 401. The side panels 125A, B can hang adjacent to the side walls 110 of the grill lid 100 inside the grill lid 100. The front panel 105 includes side flanges 111, 112, 113 at the left, right, and top edges of the front panel 105. The side flanges 111, 112, 113 are substantially perpendicular to the planar surface of the front panel 105 and extend towards the base grill 115. The side flanges 111, 112, 113 cover the left, right, and top edges of the opening 401. The side flanges 111, 112, 113 facilitate preventing heat from escaping the grill lid 100 and water from leaking inside the grill lid 100 at the opening 401. Alternatively and/or additionally, the side cover flanges 111, 112, 113 can also be equipped with flame retardant material that helps seal the front panel 105 to the grill lid 100 and softly (noise-wise) closes the front panel 105 to the grill lid 100.

The concealed grill flue 103 can be erected by pushing the side panels 125A, B upward using a lever system, spring system, pulley system and/or other similar opening systems, that are described in U.S. nonprovisional application entitled, “Grill and Method of Use Thereof,” having Ser. No. 13/712,972, filed on Dec. 13, 2012, which is a continuation of U.S. utility application entitled, “Grill and Method of Use Thereof,” having Ser. No. 12/893,130, filed on Sep. 29, 2010, which is a continuation-in-part of U.S. utility application entitled, “Grill and Method of Use Thereof,” having Ser. No. 12/574,028, filed on Oct. 6, 2009, all of which are entirely incorporated herein by reference. The opening system 200 is coupled to the grill base 115 and the grill flue 103 and assists in erecting the front panel 105 as the grill lid 100 is being opened. In this example, the concealed grill flue 103 can be erected by pushing the side panels 125A, B upward using a lever system 200. The rear panel 135 that is attached to the side panels 125A, B is pushed up in conjunction with side panels 125A, B.

Part of the lever system 200 is shown in FIG. 3, which includes a rear structure 210 that is pivotally attached to the side panel 125A at a distal end of the rear bar 210 at an attachment point 215 of the side panel 125A. The rear structure 210 can be attached to the side panel 125A using a Chicago screw. The rear structure 210 can be an elongated bar.

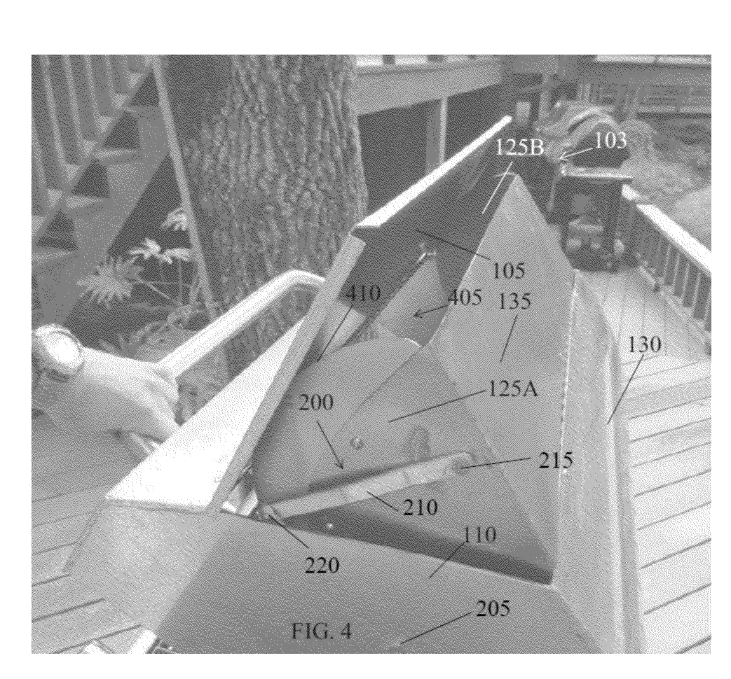

FIG. 4 is a perspective view of a grill lid 100 that illustrates an embodiment of the present invention from the rear, top, and left side views in which a concealed grill flue 103 is being partially erected using a lever system 200. Said lever system 200 includes a lever structure 225 (FIG. 5) that is pivotally attached to a sidewall 110 of the grill lid 100 and a rear bar 210 that is pivotally attached to a distal end of the lever structure 225 and the rear panel 135 at pivot attachment points 220, 215, respectively. A proximal end of the lever structure 225 is coupled to the base grill. The lever system 200 is further described in connection with FIGS. 5 and 7-14.

The side panels 125A, B includes curve edges 410 that assist in opening the concealed grill flue 103. The curve edges 410 engage the inner surface of the front panel 105 as the concealed grill flue 103 is being erected, which generates low noise due to the minimum friction between the curve edges 410 and the inner surface of the front panel 105.

The front panel 105 shields the heat and smoke that can be generated from the grill base 115 from the front of the grill as the concealed grill flue 103 is being erected. As the side panels 125A, B and the rear panel 135 erect upwardly by way of the lever system 200, a small opening 405 between the top edge of the rear panel 135 and the inner surface of the front panel 105 is formed. The opening 405 of the concealed grill flue 103 releases some heat and smoke within the grill lid 100. This initial release of heat and smoke from the opening 405 during the opening process can start the air convection going out of the grill flue 103, causing more heat and smoke to flow out of the grill flue 103 once erected.

FIG. 5 is a perspective view of a grill lid 100 having an erected grill flue 103 that illustrates an embodiment of the present invention from the front, top, and left side views. The side panels 125A, B have a trapezoid shape that substantially cover the left and right sides of the erected grill flue 103. The grill flue 103 is fully erected by way of the front panel 105 leaning on the side edges 410 of the side panels 125A, B, such side panels 125A, B being attached perpendicularly to the planar surface and at the left and right side edges of the rear panel 135, and such side panels 125A, B being held opened by the lever system 200. In this example, the erected grill flue 103 is shaped with a rectangular base and sloping sides with respect to the front and rear panels 105, 135 that converge to a smaller rectangular top opening than the rectangular base.

The convergence of the front and rear panels 105, 135 can increase the air velocity caused by the heat within the grill lid 100. This increase in air velocity can further assist in directing and channeling heat and smoke through the grill flue 103. The shape of the erected grill flue 103 can also be a flat topped pyramid, a cylinder, a cone, cube, and other three dimensional shapes. It should be noted that the rear panel 135 can be designed such that the height of the rear panel 135A is taller than the height of the front panel 105, such as that shown in dotted lines. The taller rear panel 135A can prevent wind from flowing into the top opening 405 of the grill flue 103 back into the grill opening 401 and toward the user.

Alternatively or additionally, the side panels 125 can also be designed taller to cover the left and right sides of the erected grill flue 103. It should be noted that a wind screen that extends upward and above the top of the rear panel 135 to better shield the opening 405 of the grill flue 103 from the wind blowing inside the grill flue 103 from the rear to the front of the grill. The wind screen can be separate from the grill and is similar to a portable movie screen or projection screen. Alternatively or additionally, the rear bottom corner of the side walls 110 of the grill lid 100 can be attached to an end 515 of spring 505 which is also attached to a slot on a stationary structure 510 (e.g., horizontal side surface) at an opposite end 520 of the spring 505. The spring 505 assists in opening the grill lid 100.

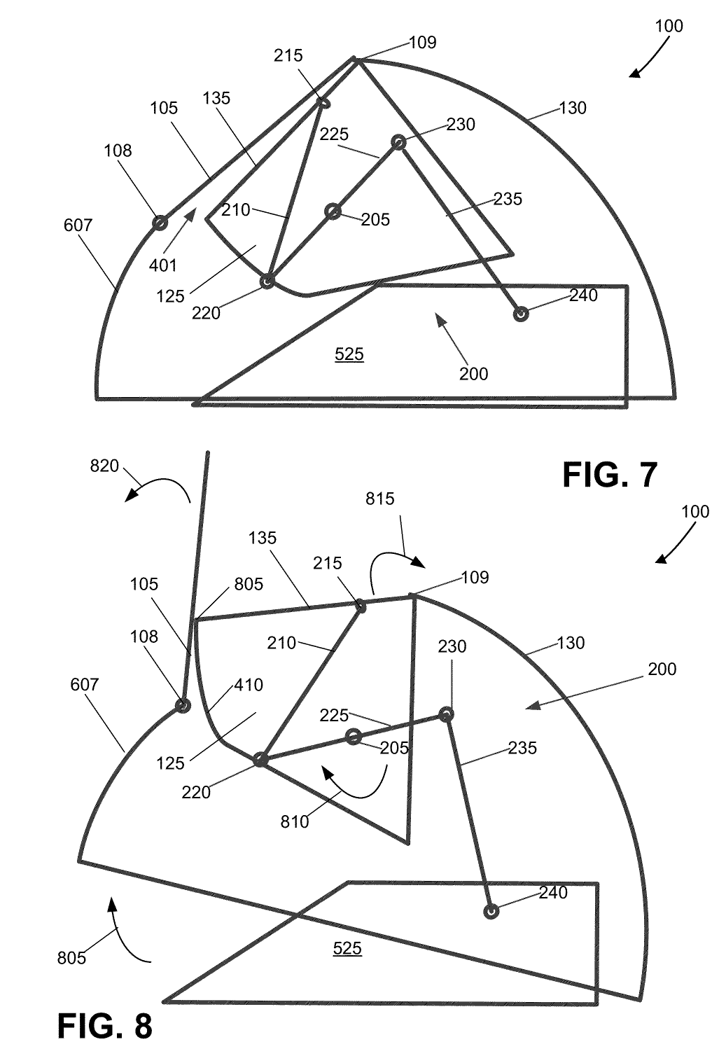

The lever system 200 includes a base structure 235 that is pivotally attached at a attachment point 235 to the grill base 115 (e.g., side panel 525), a lever structure 225 that is pivotally attached at a attachment point 205 on the side wall 110 of the grill lid 100, and a rear bar 210 that is pivotally attached at a distal end of the lever bar 225 and the side panel 125 of the grill flue 103. A proximal end of the lever structure 225 is pivotally attached to the base structure 235 (not shown, see FIG. 7). The lever system 200 is further described in connection to FIGS. 7-14. In this example, the lever structure 225 and the base structure 235 is a thin elongated bar.

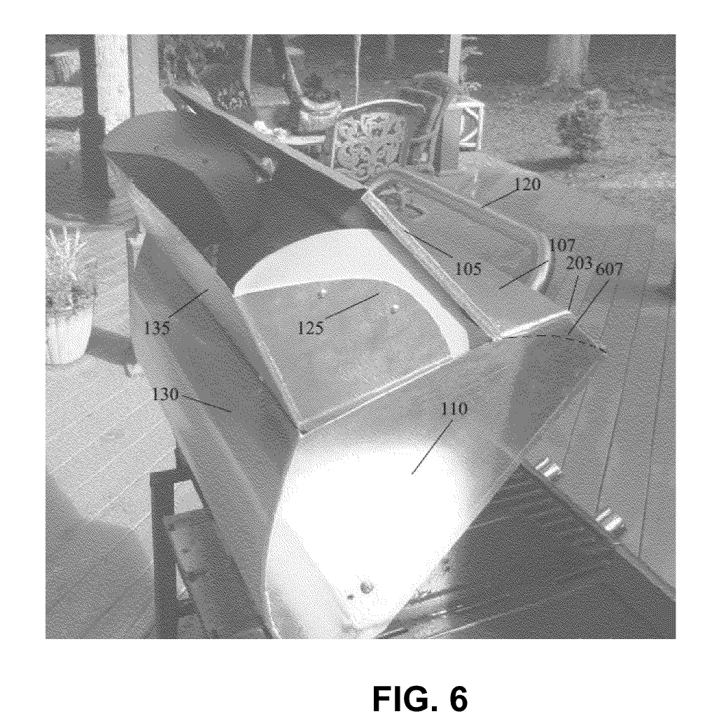

FIG. 6 is a perspective view of a grill lid 100 that illustrates an embodiment of the present invention from the rear, top, and left side views. In this example, the top wall 107 includes a corner 203 that may harbor heat and smoke and slow down the flow of heat and smoke out of the grill flue 103. Alternatively and/or additionally, the corner 203 of the top wall 107 can be eliminated and substituted with a curved wall 607 (shown in dotted lines) such that the heat and smoke can be better channeled and directed out of the opening 405 of the grill flue 103 than the design of the corner 203 of the top wall 107.

FIGS. 7-10 show the architecture, functionality and operation of a lever system 200 in accordance with an embodiment of the present invention. FIGS. 7-10 illustrate a grill lid 100 and a concealed grill flue 103 in a closed position, partially closed/opened position, and opened position. Referring to FIG. 7, a concealed grill flue 103 is positioned inside the grill lid 100 and covered by the front panel 105 of the concealed grill flue 103. In this example, the rear panel 135 and side panels 125 are positioned inside the grill lid 100 and the front panel 105 covers the opening 401 of the top wall 607 of the grill lid 100 at a closed position of the grill lid 100.

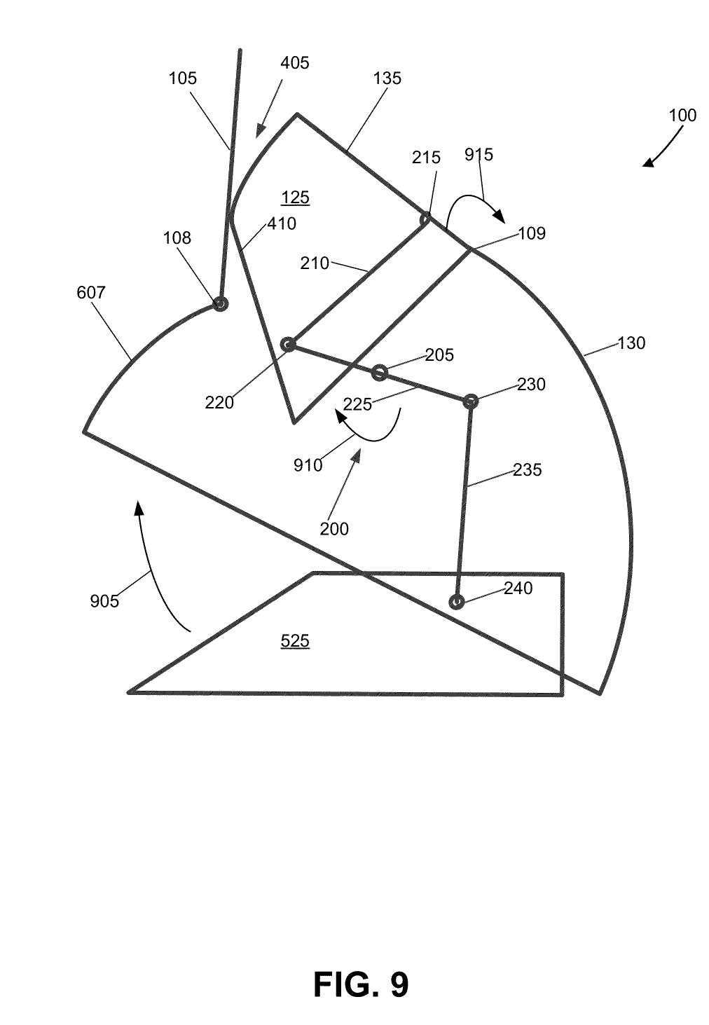

The opening system 200 includes a lever system that includes a lever structure 225 that is pivotally attached at an attachment point 205 to a sidewall 110 (FIG. 1) of the grill lid 100 and a rear bar 210 that is pivotally attached to a distal end of the lever structure 225 and the rear panel 135 at attachment points 220, 215. A base structure 235 is pivotally attached at distal and proximal ends to a proximal end of the lever structure 225 and a side panel 525 of the base grill 115 at attachment points 230, 240. Alternatively or additionally, the rear bar 210 can be pivotally attached to the side panel 125, which is attached to the rear panel 135. In this example, the lever and base structures 225, 235 are elongated bars, which will be referred to hereinafter in connection to FIGS. 8-10.

FIG. 8 shows a concealed grill flue 103 that is erecting out of the grill lid 100 as the grill lid 100 is being opened at an angle 805 of approximately 15 degrees with respect to a horizontal planar surface. In this example, the base bar 235 pulls downward the proximal end of the lever bar 225 at the pivot attachment point 230 as the grill lid 100 is raised, which in turn rotates the lever bar 225 in a clockwise direction 810 about the pivot attachment point 205. The lever bar 225 pushes the rear bar 210 and the side and rear panels 125, 135, which rotates the side and rear panels 125, 135 upward in a clockwise direction 815 about the hinge 109. As the rear panel 135 rotates upward, the rear panel 135 engages the inner surface of the front panel 105 and pushes/rotates the front panel 105 upward about the hinge 108 in a counterclockwise direction 820.

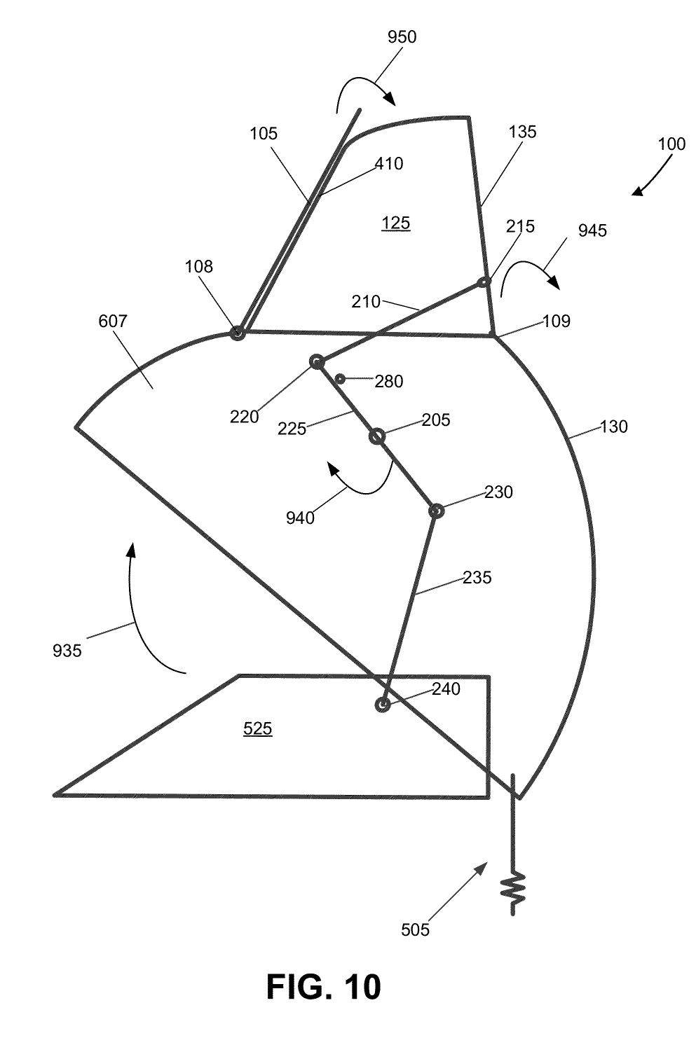

FIG. 9 shows a concealed grill flue 103 that is erecting out of the grill lid 100 as the grill lid 100 is being opened at an angle 905 of approximately 27 degrees with respect to a horizontal planar surface. In this example, the base bar 235 pulls further downward the proximal end of the lever bar 225 at the pivot attachment point 230 as the grill lid 100 is raised, which in turn rotates the lever bar 225 in a clockwise direction 910 about the pivot attachment point 205. The lever bar 225 pushes the rear bar 210 and the side and rear panels 125, 135, which rotates the side and rear panels 125, 135 upward in a clockwise direction 915 about the hinge 109. As the side and rear panels 125, 135 rotate upward, the side panel 125 engages the inner surface of the front panel 105 as the rear panel 135 moves away from the front panel 105 towards the rear wall 130 of the grill lid 100.

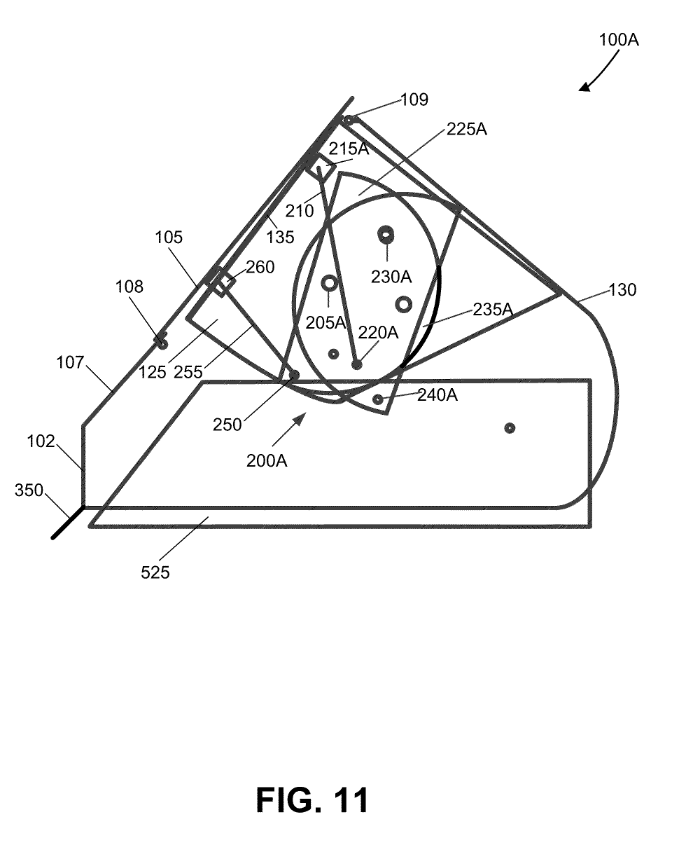

FIG. 10 shows a grill flue 103 that is erected out of the grill lid 100 in an opened position of the grill lid 100. In this example, the base bar 235 pulls further downward the proximal end of the lever bar 225 at the pivot attachment point 230 as the grill lid 100 is raised in direction 935, settling in the opened position, which in turn rotates the lever bar 225 in a clockwise direction 940 about the pivot attachment point 205. The lever bar 225 pushes the rear bar 210 and the side and rear panels 125, 135, which rotates the side and rear panels 125, 135 upward in a clockwise direction 945 about the hinge 109. As the side and rear panels 125, 135 rotate upward, the side panel 125 engages the inner surface of the front panel 105 as the rear panel 135 moves away from the front panel 105 towards the rear wall 130 of the grill lid 100.

The front panel 105 rotates in the clockwise direction 950 about the hinge 108 and rests on the side edge 410 of the side panel 125. The lever system 200 can include a limiter (e.g., a pin or a bolt) 280 that is attached to the side wall 110 of the grill lid 100 to stop the lever bar 225 from rotating clockwise at a predetermine position, e.g., at an erected grill flue position. The limiter 280 also stops the grill lid 100 from opening any further. The bottom rear portion of the grill lid 100 can be attached to a spring 505 that is attached to the grill base 115 to assist in opening and keeping the grill lid 100 opened. The spring 505 also assists in lowering the grill lid 100 to the closed position.

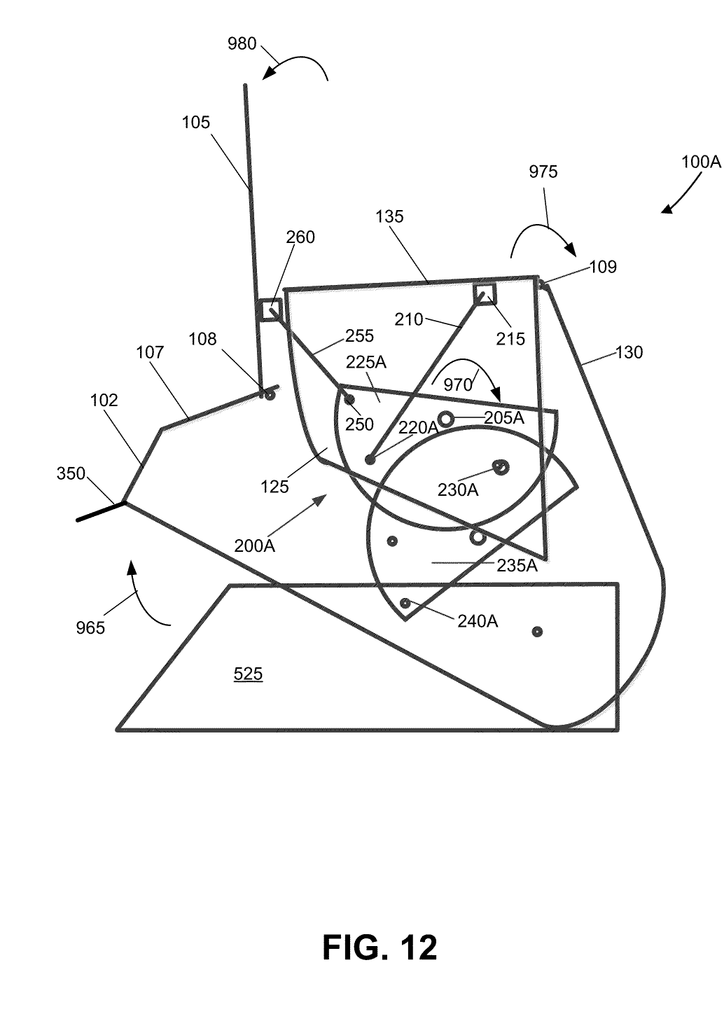

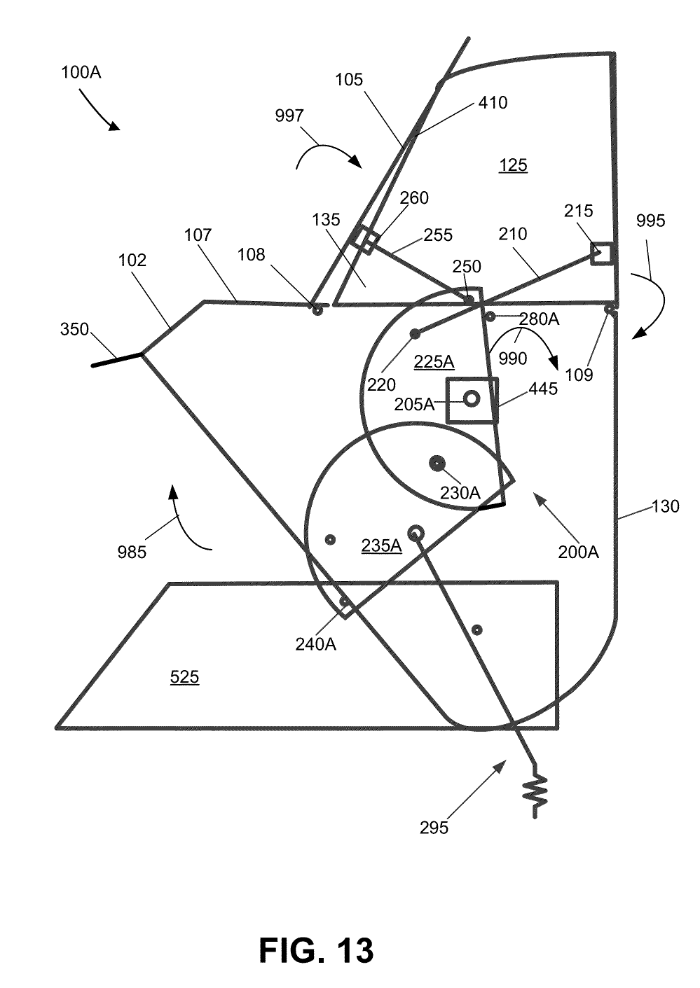

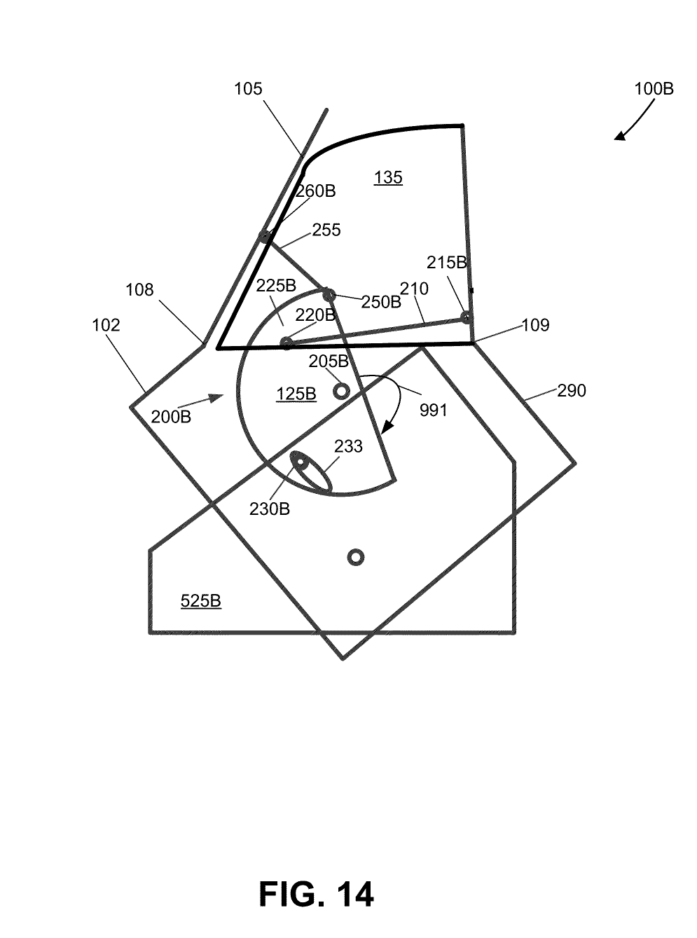

FIGS. 11-13 show the architecture, functionality and operation of a lever system 200A in accordance with another embodiment of the present invention. FIGS. 11-13 illustrate a grill lid 100 and a concealed grill flue 103 in a closed position, partially closed/opened position, and opened position. FIG. 11 shows a concealed grill flu 103 that is positioned inside the grill lid 100 and covered by the front wall 105 of the grill flue 103 in a closed position of the grill lid 100. In this example, the base structure and lever structure are partial gears 225A, 235A, which function similarly to the lever and base bars 225, 235 and will be referred to as lever and base gears 225A, 235A hereinafter in connection to FIGS. 12-13.

The lever gear 225A is pivotally attached at an attachment point 205A to a sidewall 110 (FIG. 1) of the grill lid 100 and a rear bar 210 that is pivotally attached to a distal end of the lever gear 225A and the rear panel 135 at attachment points 220A, 215A. The base gear 235A is pivotally attached at distal and proximal ends to a proximal end of the lever structure 225 and the side panel 525 of the base grill 115 at attachment points 230A, 240A. The lever system 200A includes a front bar 255 that is pivotally attached at the distal end of the lever gear 225A and the front panel 105 at attachment points 250, 260. As will be shown in FIGS. 12-13, the front bar 255 and the lever gear 225A open, close and rotate the front panel 105 of the grill flue 103 about the hinge 108 such that the side and rear panels 125, 135 do not engage the inner surface of the front panel 105. This reduces the noise generated by the friction between the front, side, and rear panels 105, 125, 135. The grill lid 100A includes a front flange 350 that is attached to the front wall 102 of the grill lid 100A and extends outwardly away from the grill lid 100A.

FIG. 12 shows a concealed grill flue 103 that is erecting out of the grill lid 100A as the grill lid 100A is being opened at an angle 965 of approximately 30 degrees with respect to a horizontal planar surface. In this example, the base gear 235A pulls downward the proximal end of the lever gear 225A at the pivot attachment point 230A as the grill lid 100A is raised, which in turn rotates the lever gear 225A in a clockwise direction 970 about the pivot attachment point 205A. The lever gear 225A pushes the front and rear bars 255, 210 and the side and rear panels 125, 135, which rotates the side and rear panels 125, 135 upward in a counter clockwise direction 980 and clockwise direction 975 about the hinges 108, 109, respectively. As the lever gear 225A rotates in a clockwise direction 975, the front bar 255 pushes the front panel 105 away from the side and rear panels 125, 135 such that the side and rear panels 125, 135 do not engage the front panel 105 as the side and rear panels 125, 135 are being erected.

FIG. 13 shows a grill flue 103 in an erected position responsive to the grill lid 100A being in an opened position. In this example, the base gear 235A pulls further downward the proximal end of the lever gear 225A at the pivot attachment point 230A as the grill lid 100A is raised in direction 985 to be placed in the opened position, which in turn rotates the lever gear 225A in a clockwise direction 990 about the pivot attachment point 205A. The lever gear 225A pushes the rear bar 210 and the side and rear panels 125, 135, which rotates the side and rear panels 125, 135 upward in a clockwise direction 995 about the hinge 109. As the side and rear panels 125, 135 rotate upward in an erect/opened position, the front bar 225 and the lever gear 225A pulls the front panel 105 towards the side panel 125. The front panel 105 rotates in the clockwise direction 997 about the hinge 108 and rests on the side edge 410 of the side panel 125.

Alternatively or additionally, the lever gear 225A can include a mainspring and/or a motor 445 that assists in the opening of the grill lid. The mainspring 445 can be wounded to rotate the lever gear 225A in the clockwise direction 990 about the pivot attachment point 205A. The motor 445 can be designed to rotate the lever gear 225A in both the clockwise and counter clockwise directions. A sensor (e.g., a touch sensor) can be placed at a handle 420 (FIG. 17) and communicates with the motor to rotate the lever gear 225A. The lever system 200A can include a limiter (e.g., a pin, a bolt, a position sensor) 280A that is attached to the side wall 110 of the grill lid 100A to stop the lever gear 225A from rotating clockwise at a predetermine position, e.g., at an erected grill flue position. The limiter 280A can be positioned such that the front panel 105 is adjacent but does not rest on the side panel 125. This reduces noise generated from the front panel 105 engaging the side panel 135. The limiter 280A also stops the grill lid 100A from opening further than a predetermined position. A spring 295 can be attached to the base gear 235A and the grill base 115 to assist in opening and keeping the grill lid 100a opened. The spring 295 also assists in lowering the grill lid 100A to the closed position. A front flange 350 in the opened position of the grill lid 100A assists in directing heat and smoke around the bottom of the front wall 102 towards the inside of the grill lid 100A and away from a user.

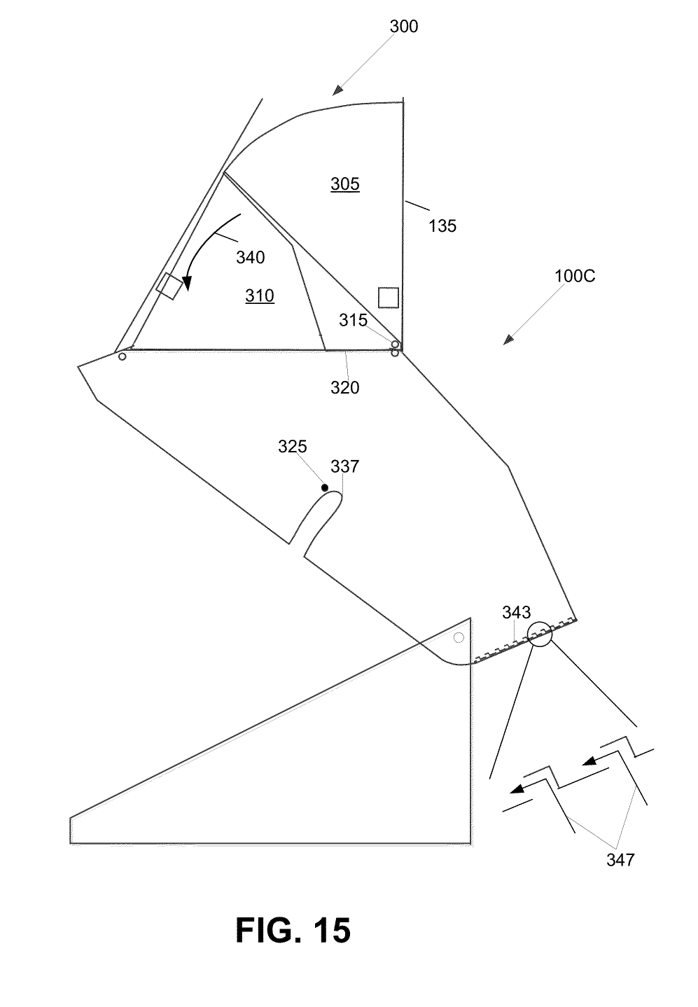

FIG. 14 shows an erected grill flue 103 on a roll top grill lid 100B in accordance with an embodiment of the present invention. The lever system 200B in FIG. 14 is similar to the lever system 200A such as that shown in FIGS. 11-13. The lever system 200B includes a lever gear 225B that pivotally attaches at an attachment point 230B to a high side panel 525B of the grill base 115 by way of a pin or a bolt/nut, for example. The attachment point 230B can move around in a slot 233 on the high side panel 525B, allowing the lever gear 225B to rotate in the clockwise direction 991 about the pivot attachment point 205B as the grill lid 100B is raised from a closed position to an opened position.

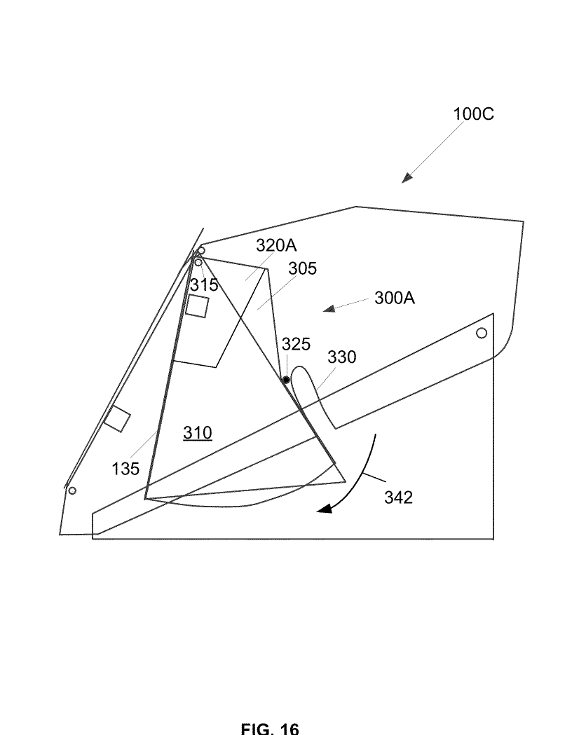

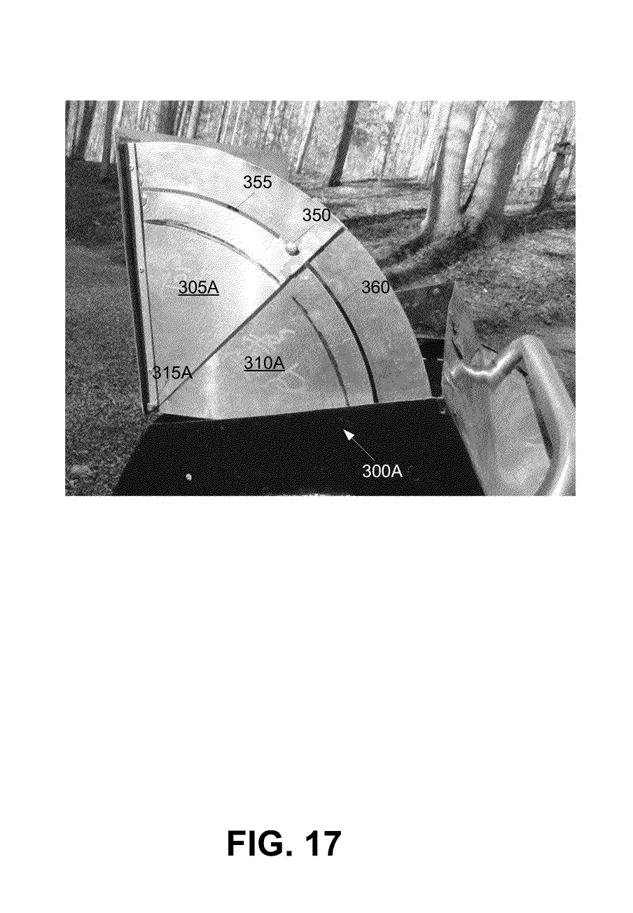

FIGS. 15-16 are cross-sectional side views of a side panel 300 of a grill flue 103 that includes a first portion 305 and a second portion 310 that slides along the surface of the first portion 305. FIG. 15 shows an erected grill flue 103 with an erected side panel 300. The first and second portions of the side panel 300 are pivotally attached at the bottom right corner of the side panel 300 at attachment point 315. As the side panel 300 is being erected, the second portion 310 rotates in the counterclockwise direction 340 and engages a flange structure 320 at the bottom edge of the first portion 305. The flange structure 320 can extend substantially perpendicular to the planar surface of the first portion 305 such that the flange structure 320 can engage and stop the second portion 310 from rotating further that a predetermined position. The grill lid 100B can include rear panel 343 having raised perforations that can deflect the wind in direction 347 in the opened position to reduce or prevent the wind from entering the rear of the grill lid 100B. In the closed position, the rear panel 343 can allow the heat and smoke to escape out of the raised perforations.

FIG. 16 shows a concealed grill flue 103 with an unerected side panel 300. As the grill lid 100C closes, the side panel engages a limiter 325 (e.g., a pin or a bolt/nut) that prevents the second portion 310 from moving across a slot 330 for a rotisserie device, for example, causing the second portion 310 to rotate in the clockwise direction 342 about the pivot attachment point 315 towards the rear panel 135. Alternatively or additionally, the first portion 305 of the side panel 300A can include a cover structure 320A, which can be folded at the bottom edge of the first portion 305 (to be consistent with the terminology in FIG. 15) and positioned adjacent to the surface of the first portion 305. The cover structure 320A being folded can engage and stop the second portion 310 from rotating further than a predetermined position in the erected position and can house the second portion 310 between the cover structure 320A and the first portion 305 in the unerected position.

FIG. 17 is a side view of another embodiment of a side panel 300A. This side panel 300A includes first and second portions 305A, 310A that is pivotally attached at an attachment point 315A. The first and second portions include slots 355, 360 that radially extend between the side edges of the first and second portions 305A, 310A. An attachment 350 (e.g., a screw or a bolt/nut) is placed through the slots 355, 360 allowing the second portion 310A to slide towards or away from the rear panel 135 about the pivot attachment point 315A and along the surface of the first portion 305A.

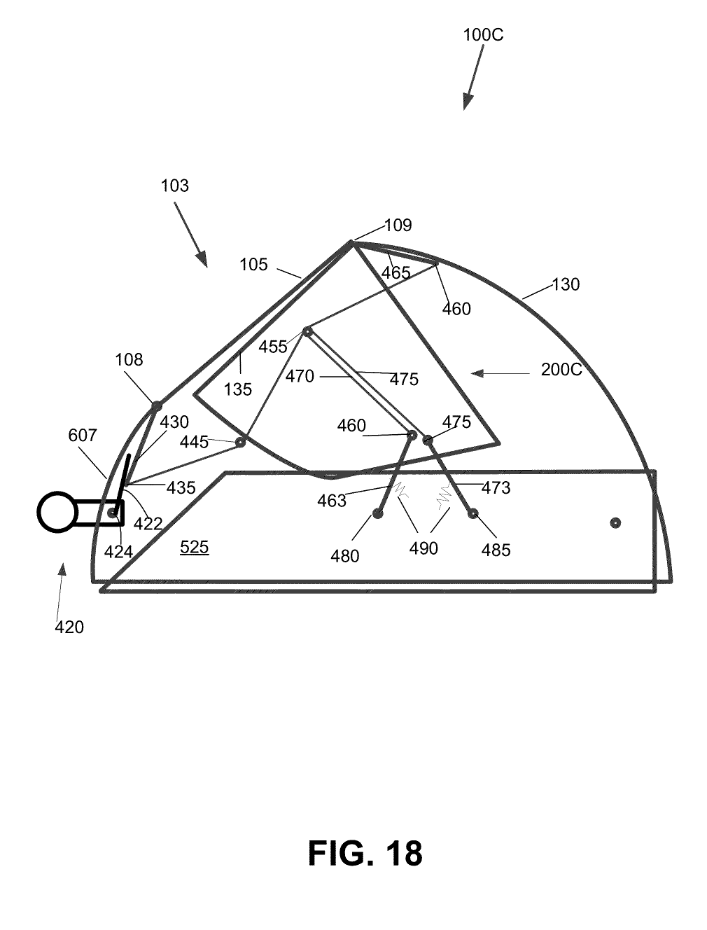

FIGS. 18-21 are cross-sectional views of a grill lid having a grill flue 103 that can be erected by way of a pulley system 200C, which includes a cable wire 470 that is attached to the front panel 105 and the base grill 115. FIG. 18 shows the grill lid 100C and the grill flue 103 in a closed position. The pulley system 200C also includes a cable wire 475 that is attached to the rear panel 135 and the base grill 115. In this example, the front panel 105 is attached to an extended front arm 430 at the hinge 108 and/or the bottom edge of the front panel 105. An end of the extended front arm 430 is attached to the cable wire 470 which is routed under a first roller 445 and above a second roller 455 and attached at a distal end 460 of a first base bar 463, which is attached at the proximal end 480 to the side panel 525 of the grill base 115.

The rear panel 135 is attached to an extended rear arm 465 at the hinge 109 and/or the bottom edge of the rear panel 135. An end of the extended rear arm 465 is attached to the cable wire 475 which is routed over the second roller 455 and attached at a distal end 460 of a second base bar 473, which is attached at the proximal end 480 to the side panel 525 of the grill base 115. The first and second base bars 463, 473 are attached to a spring system 490 the provides tension to the cable wire as the front panel 105 and the rear panel 135 by way of the extended rear arm 465 rest on the rear wall 130 of the grill lid 100.

Alternatively or additionally, the first and second base bars 463, 473 can be replaced with retractable cable wire devices. An actuation handle 420 can be attached to a front wall 607 of the grill lid 100. The actuation handle 420 includes a rotating lever 422 that rotates/pushes the extended front arm 430 of the front panel 105 to open the front panel 105 to allow smoke and heat to escape. The rotating lever 422 can be coupled to a cable wire that is coiled around a pivot structure 424 of the rotating lever 422 and attached to the actuation handle 420 that can rotate. As the actuation handle 420 rotates, it pulls the cable wire coiled around the pivot structure 424, rotating the rotating lever 422.

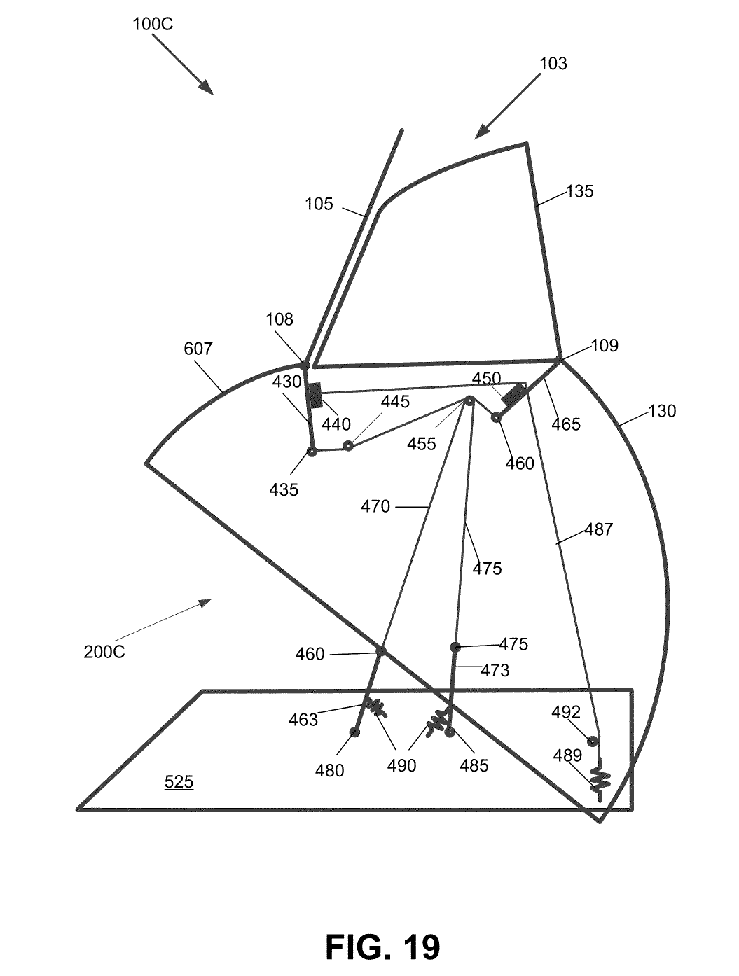

FIG. 19 shows the grill lid 100C and grill flue 103 in an opened position using the pulley system 200C. As the grill lid 100C is raised, the second roller 455 is in turn raised, causing the second roller 455 to pull on the cable wires 470, 475, which in turn pull the extended front and rear arms 430, 465 towards the second roller 455. The pulled extended front and rear arms 430, 465 rotate the front and rear panels 105, 135 about the hinges 108, 109, erecting the front, side, and rear panels 105, 125, 135 into an erected grill flue 103. The pulley system 200C includes stop bars 440, 450 that prevent the extended front and rear arms 430, 465 for moving further than a predetermined position. The stop bars 440, 450 can be attached to the side wall 110 of the grill lid 100. The pulley system 200C can include an opening assist system that includes a cable wire 487 that is attached to the stop bar 440. The cable wire 487 is routed above the stop bar 450 and down towards the right side of the pivot attachment point 492 of the grill lid 100 and grill base 115. The cable wire 487 is attached to a spring structure 489, which is attached to the grill base 115. As the grill lid 100C is being opened, the opening assist system assists in pulling the grill lid 100C at the front wall 107 by wall of the stop bar 440 upward and backward towards the rear wall 130 of the grill lid 100C. The opening assist system can also assist in slowly closing the grill lid 100C.

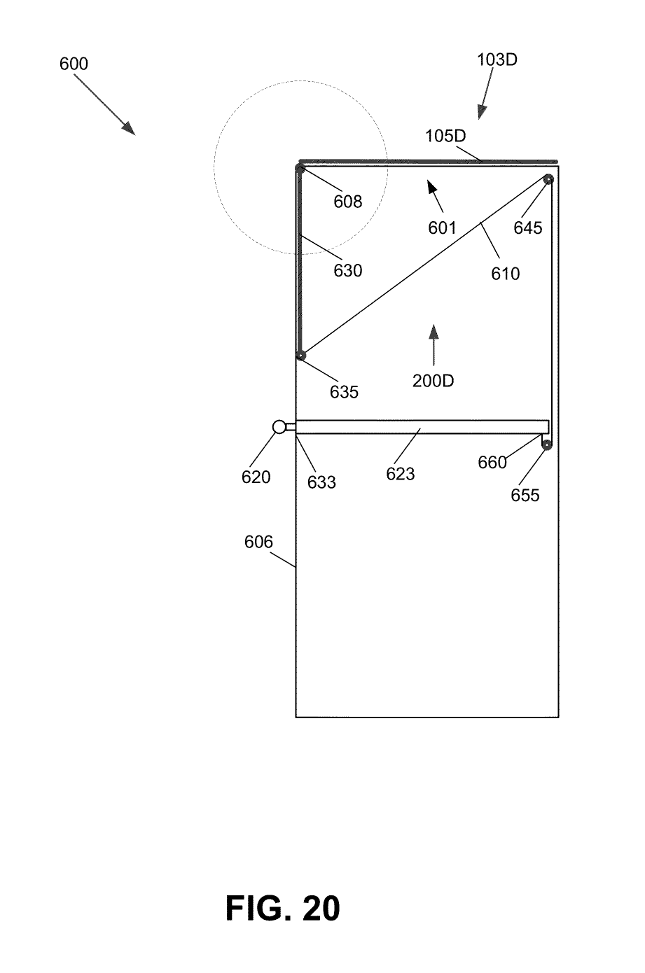

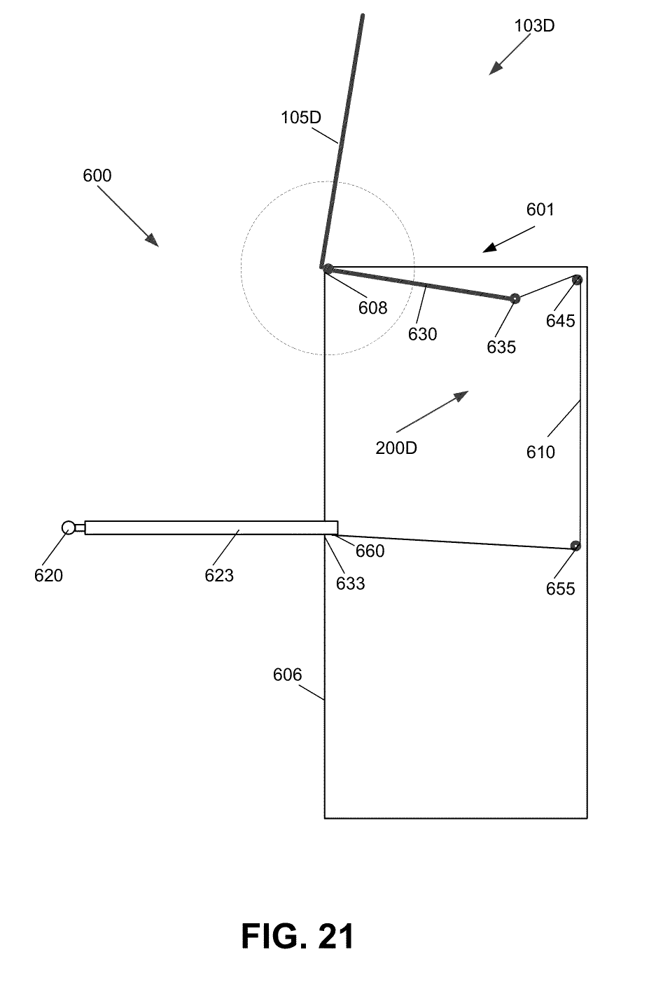

FIGS. 20-21 are cross-sectional views of a grill 600 having a grill flue 103D that can be erected by way of a pulley system 200D, which includes a cable wire 610 that is attached to a front panel 105D and a grill tray 623. In this example, the grill 600 is a smoker having a cylindrical housing 606 with a top opening 601. FIG. 20 shows the grill tray 623 positioned inside the housing 606 and the front panel 105D covering the top opening 601 and resting on the top edge of the housing 606 in a closed position. The front panel 105D is in hinged communication (via a hinge 608) at the top edge of the housing 606. The front panel 105D is attached to an extended front arm 630 at a hinge 608 and/or the bottom edge of the front panel 105D. An end of the extended front arm 630 is attached to the cable wire 610 which is routed over a first roller 645 and down towards the right side of a second roller 655. The cable wire 610 is routed downward and upward to the left side of the second roller 655 and attached at a distal end 660 of the grill tray 623. The grill tray 623 slides in and out of a slot 633 at the housing 606.

FIG. 21 shows the grill tray 623 and grill flue 103D in an opened position using the pulley system 200D. As the grill tray 100 is pulled out of the housing 606 through the slot 633, the grill tray 623 pulls the cable wire 610, which in turn pulls the extended front arms 630 towards the first roller 645. The pulled extended front arm 630 rotates the front panel 105D about the hinge 608 into an erected grill flue 103D. The heat and smoke are directed through the opening 601 of the grill 600 in the opened position of the grill tray 623 and grill flue 103D.

In addition or alternatively, the concealed grill flue 103 described above can be a modular unit (not shown). The operation and functionality of the modular concealed grill flue is the same as the concealed grill flue 103 described above except that the panels 105 and 135 are hingeably attached to a modular base and such modular base is attached at the edges of the opening on the top wall 107. The modular base can have the shape of the opening on the top wall 107. For example, the modular base can be a flat bar having a square shape that can be attached to the square opening at the top wall 107. The modular concealed grill flue can improve the assembling the grill flue on the grill lid 100 the faster.

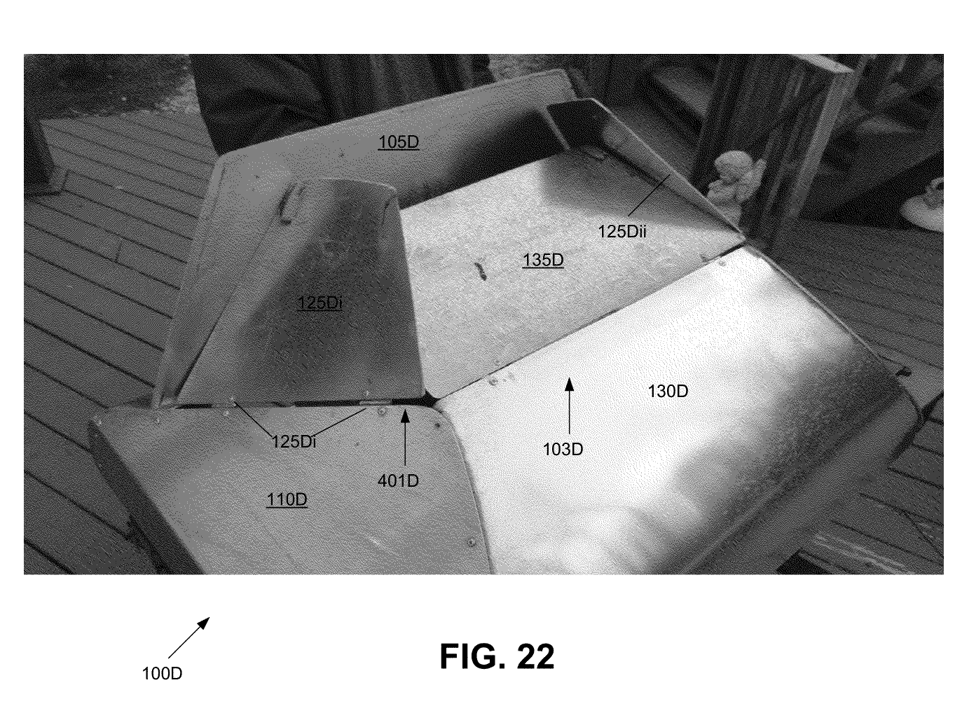

FIG. 22 is a perspective view of a grill lid 100D that illustrates an embodiment of the present invention from the top, side, and rear views. The grill lid 100D includes side panels 125D that are hinged at side edges of the opening 401 of the top wall of the grill lid 100D. The front, rear, and side panels 105D, 125D, 135D forms a grill flue 103D in an erected position. In a closed position, the side panel 125Di can be folded inside the grill lid 100D at the most bottom position; the rear panel 135D folds on top of the side panel 125Di; the side panel 125Dii folds on top of the rear panel 135D; the front panel 105D folds on top of the side panel 125Dii and covers the opening 401D. The grill flue 103D can use the opening system 200 previously discussed to open and close the grill flue 103D.

This description has been presented for purposes of illustration and description. It is not intended to be exhaustive or to limit the disclosure to the precise forms disclosed. Obvious modifications or variations are possible in light of the above teachings. The embodiments discussed, however, were chosen to illustrate the principles of the disclosure, and its practical application. The disclosure is thus intended to enable one of ordinary skill in the art to use the disclosure, in various embodiments and with various modifications, as are suited to the particular use contemplated. All such modifications and variation are within the scope of this disclosure, as determined by the appended claims when interpreted in accordance with the breadth to which they are fairly and legally entitled.

What is claimed is:

1. A grill comprising:
a grill base;
a grill lid that is in hinged communication with the grill base and includes an opening on a top wall of the grill lid;
a grill flue that includes a front panel that is in hinged communication with the grill lid at the opening of the top wall of the grill lid; and
an opening system that is coupled to the grill base and the grill flue and assists in erecting the front panel as the grill lid is being opened.

2. The grill of claim 1, wherein the grill flue further includes a rear panel that is in hinged communication at the opening of the top wall of the grill lid, wherein the front and rear panels are hinged at a front edge and rear edge of the opening of the top wall of the grill lid.

3. The grill of claim 2, wherein the grill flue further includes side panels.

4. The grill of claim 3, wherein the side panels are attached to the rear panels.

5. The grill of claim 3, wherein the side panels are hinged at side edges of the opening of the top wall of the grill lid.

6. The grill of claim 3, wherein the side panels include a first portion and a second portion that slides along the surface of the first portion.

7. The grill of claim 2, wherein the rear panel is positioned inside the grill lid and the front panel covers the opening of the top wall of the grill lid at a closed position of the grill lid.

8. The grill of claim 2, wherein the opening system includes a lever system that includes a lever structure that is pivotally attached to a sidewall of the grill lid and a rear bar that is pivotally attached to a distal end of the lever structure and the rear panel, wherein a proximal end of the lever structure is coupled to the base grill.

9. The grill of claim 8, wherein the lever system further includes a base structure that is pivotally attached at a distal end to a proximal end of the lever structure, wherein a proximal end of the base structure is pivotally attached to the base grill.

10. The grill of claim 8, wherein the lever system includes a front bar that is pivotally attached to the distal end of the lever structure and the front panel.

11. The grill of claim 10, wherein the lever structure includes a mainspring or a motor that assists in the opening of the grill lid.

12. The grill of claim 2, wherein the opening system includes a pulley system that includes cable wires that are attached to the front panel and the base grill.

13. The grill of claim 12, wherein the cable wires of the pulley system are attached the rear panel and the base grill.

14. The grill of claim 1, wherein the opening system includes a pulley system that includes cable wires that are attached to the front panel and a grill tray.

15. The grill of claim 1, wherein the grill lid further includes an actuation handle that is attached to a front wall of the grill lid, wherein the actuation handle includes a rotating lever that pushes an extended front arm of the front panel to open the front panel, wherein the grill lid includes a front flange that is attached to a front wall of the grill lid and extends outwardly away from the grill lid.

16. A grill lid comprising:
a top wall that includes an opening;
a grill flue that includes a front panel that is in hinged communication at the opening of the top wall; and
an opening system that is coupled to a grill base and the grill flue, wherein the opening system assists in erecting the front panel as the grill lid is being opened.

17. The grill lid of claim 16, wherein the grill flue further includes a rear panel that is in hinged communication at the opening of the top wall of the grill lid, wherein the front and rear panels are hinged at a front edge and rear edge of the opening of the top wall of the grill lid.

18. A lever system for a grill lid that includes a grill flue comprising:
a lever structure that is pivotally attached to a sidewall of a grill lid; and
a rear bar that is attached to a distal end of the lever structure and a rear panel of a grill flue, wherein a proximal end of the lever structure is coupled to a base grill.

19. The lever system of claim 18, further comprising a base structure that is pivotally attached at a distal end to a proximal end of the lever structure, wherein a proximal end of the base bar is pivotally attached to the base grill.

20. The lever system of claim 19, further comprising a front bar that is pivotally attached to the distal end of the lever structure and the front panel, wherein the proximal end of the lever structure is coupled to the base grill.
